(19) United States
(12) Patent Application Publication
(10) Pub. No.: US 2009/0277394 A1
(43) Pub. Date: Nov. 12, 2009

(54) Odor reducing pet collar

(76) Inventors: Richard Paul Mitrano, Andover, MA (US); Cynthia Jean Mitrano, Andover, MA (US)

Correspondence Address: Richard P. Mitrano, 106 Wildwood Road, Andover, MA, 01810, US

(21) Appl. No.: 12/387,448

(22) Filed: May 2, 2009

Related U.S. Application Data
(60) Provisional application No. 61/126,837, filed on May 7, 2008.
(60) Provisional application No. 61/126,836, filed on May 7, 2008.
(60) Provisional application No. 61/126,790, filed on May 7, 2008.

(51) Int. Cl. A01K 29/00

(52) U.S. Cl. 119/654; 119/653

(57) ABSTRACT

A collar worn around a pet's neck incorporating an activated carbon element to remove odors, a permeable cover to encase the activated carbon element, and a tie and attachment to secure the collar. When encircled around the neck of a pet, odors originating from the pet are captured by the activated carbon particles. Activated carbon is a material of considerable surface area consisting of millions of pore structures within each carbon particle. As a result, each gram of carbon contains up to, and in some cases, exceeding 500 square meters of surface area. The activated carbon adsorbs the pet odors rather than allowing those odors to be dispersed by the pet. After its usefulness has been exhausted, the collar is discarded and a new one is attached to the pet.

### CROSS REFERENCE TO RELATED APPLICATIONS

This application is based on provisional application Ser. No. 61/126,837, filed on May 7, 2008, provisional application Ser. No. 61/126,836, filed on May 7, 2008, and provisional application Ser. No. 61/126,790, filed on May 7, 2008.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of odor removal and more specifically to pet odor removal used in an Odor Reducing Pet Collar and the like.

Care for a pet includes bathing and grooming the pet. These activities are essential for the health of the pet. Typically, a clean and groomed pet is one that does not produce offensive odors. There are certain breeds that tend to emit offensive odors even with frequent bathing and grooming and as such, normal grooming is not sufficient to effectively control a pet's odor. The embodiments described herein contain articles, which effectively remove persistent pet odors.

The embodiment uses activated carbon as the means for pet deodorization. Activated carbon is a material of considerable surface area consisting of millions of pore structures within each carbon particle. As a result, each gram of carbon contains up to, and in some cases, exceeding 500 square meters of surface area. Activated carbon “works” by the process of adsorption. This is when one material adheres to the surface of another material by means of a physical or chemical attraction between the two materials. The carbon and the odors are thus unchanged chemically. Organic odor molecules from the air are attracted to the internal carbon surface. These contaminates accumulate on the carbon's interior surface until an equilibrium level is reached between the concentration on the carbon surface and the concentration remaining in the air.

Others have designed pet collars in an attempt to solve pet odor problems. There have been numerous pet collars to cover up, but not remove odors. U.S. Pat. No. 2,808,030 “DEODORIZING DOG COLLAR”, Costanzo attempted to solve the odor problems using a perfumed deodorizing agent in cake form. The perfumed cake gives off deodorizing fumes. In another attempt to solve the pet odor problem, U.S. Pat. No. 3,477,409 “ANIMAL DEODORIZING COLLAR ATTACHMENT” was published. Again Costanzo used a deodorizing cake of sorts to allow escaping perfumes intended to cover up any odors of the pet. In a similar manner U.S. Pat. No. 4,926,784 entitled “PET DEODORIZE DEVICE” Brightful uses a method of masking the pet odor. The method of containment for said deodorant is different that Costanzo, but it, like the other prior art uses a deodorant as the mechanism to mask pet odor. Still another attempt was made with U.S. Pat. No. 6,101,981 entitled “PET COLLAR” where Friend et al. uses a scent-producing element to mask offensive pet odors.

The prior art addressed the pet odor problem with perfumed agents to mask pet odors. These agents resided in the collar itself or in an attachment to a conventional collar. These agents would then be replenished at some interval while maintaining the carrier for said agent. The problem with these types of designs are that they cover up rather than absorb and entrap the odors, they require refilling, and the pet owner must handle the agent to be used for deodorizing and the like. These shortcomings lend the prior art to masking the odors rather that capturing them; the prior art simply traded one odor for another.

There is a need to address the actual pet odors, trapping to eliminate them in an effective manner. The need is extended to the convenience and effectiveness of an article, which is disposable after use.

### BRIEF SUMMARY OF THE INVENTION

The primary object of the invention is to provide a pet odor-reducing element in the form of a collar. Another object of the invention is to provide a pet odor-reducing element, which attaches to an existing collar. Another object of the invention is to provide a pet odor-reducing element in the form of a pet pad or bed. A further object of the invention is to provide a pet odor-reducing element, which is disposable and easy to replace.

Other objects and advantages of the present invention will become apparent from the following descriptions, taken in connection with the accompanying drawings, wherein, by way of illustration and example, an embodiment of the present invention is disclosed.

It is clear that the masking of pet odors by some means rather than capturing and eliminating the odors is, by design, less than ideal. It is the purpose of this invention to pride a superior method of reducing pet odors by trapping and eliminating said odors. In accordance with a one embodiment of the invention, there is disclosed an article of manufacture worn around a pet's neck for removing pet odors comprising: An activated carbon element to remove odors, a permeable cover encasing the activated carbon element, and a tie and attachment means to secure the collar or collar attachment. In the embodiment, the pet deodorizer contains activated carbon on non-woven polyester or other substrate. Enhanced rates of adsorption are achieved due to the increased surface area of the activated carbon. Because the adsorbent is bonded to the substrate, the bonded substrates are easy to handle and process which simplifies manufacturing. The physical size of the element is proportioned to the size of the pet. Approximate dimensions of the activated carbon strip are 16 inches long, 0.75 inches wide, and 0.25 inches deep. The substrate is covered with a sewn permeable fabric layer. The ends of the covered carbon strip have attachment means sewn to the permeable fabric. In the one embodiment, the attachment means are hook and loop fasteners although any suitable means, which will enable said encased carbon to be encircled and secured around a pet's neck for the purpose of deodorizing said pet is suitable. These may include fabric or string ties, buckles, buttons or the like. Another embodiment is to create the permeable fabric covered carbon strip for attachment to a conventional pet collar. As in the previous embodiment, attachment methods such as ties hook and loop and others are used. The shape of said attachment can be rectangular as in the one embodiment, “dog bone” shape, or any shape that allows the carbon strip to be covered with a permeable fabric and attached to a conventional collar. Placement can be between the pet and the conventional collar, hanging from or attached to a conventional collar, or other methods within the spirit of the embodiments.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a cut-away perspective view of the collar embodying the invention

FIG. 2 is a section view of the collar embodying the invention.

FIG. 3 is a view of the collar embodying this invention showing its intended use.

FIG. 4 is a section view of alternate embodiment of the invention.

FIG. 5 is a section view illustrating the components of the alternate embodiment of the invention.

FIG. 6 is a section view illustrating the components of a collar attachment as an alternate embodiment of the invention.

FIG. 7 is a view of the collar attachment alternate embodiment of this invention showing its intended use.

FIG. 8 is a perspective view of a pet pad as an alternate embodiment of the invention.

FIG. 9 is a view of the pet pad embodying this invention showing its intended use.

### DETAILED DESCRIPTION OF THE PREFERRED EMBODIMENTS

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

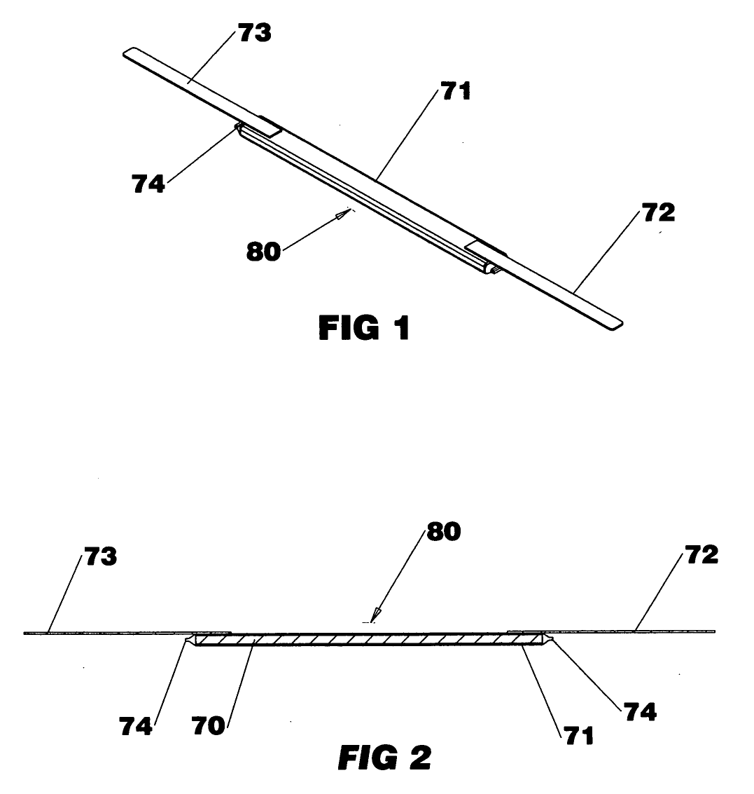

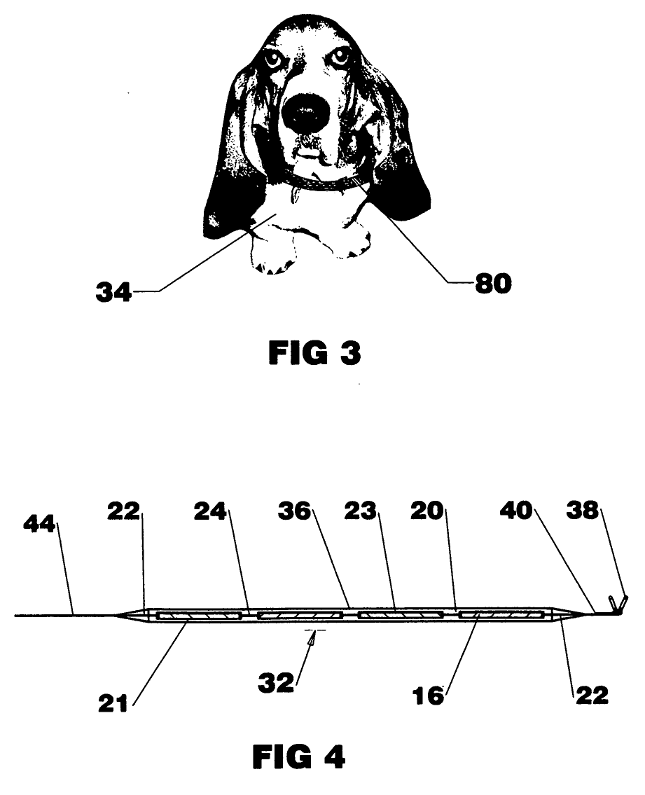

In one embodiment, as depicted in FIG. 1 and FIG. 2 illustrate the Collar Assembly 80, a permeable fabric element 71 is manufactured in the shape of an extruded rectangle or sleeve. On one end of the fabric, a hook fastener half 72 is attached. On the opposite end, a loop fastener half 73 is attached. The activated carbon strip 70 is inserted into the formed permeable fabric 71 thereby encasing the carbon strip 70. Each end of the permeable fabric 71 is sewn 74 to retain the carbon strip 70. In use, the completed article is worn around a pet's neck thereby creating the collar. FIG. 3 illustrates this Collar Assembly 80 embodiment in its intended use attached to pet 34.

An alternate configuration of the collar assembly 32 is illustrated in FIG. 4 and FIG. 5. The collar is comprised of a pouch assembly 20 and a permeable fabric shell 36. The pouch assembly is fabricated using a porous material 21 and is stitched to form individual pouches 23 by means of stitching 24.

A flat region of the material 21 continues which creates a tongue 22, which is used to attach further in the assembly process. The pouches are used to create confined areas in which granular activated carbon 16 are retained as the active agent in removing odors.

The internal carbon pouch assembly 20 is complete and will be used in the deodorized pet collar 32

On one end of the collar 32 there is a buckle mechanism 38, which is attached with stitching 40 to secure said buckle. The internal carbon pouch assembly 20 is secured into the pet collar body 36 by means of stitching 40 though the pet collar body 36 and the internal carbon 20. On end opposite the buckle 38, the basic tube is sewn flat to create a “tongue” 44 by which the collar is secured to the pet 34 by means of the buckle 38.

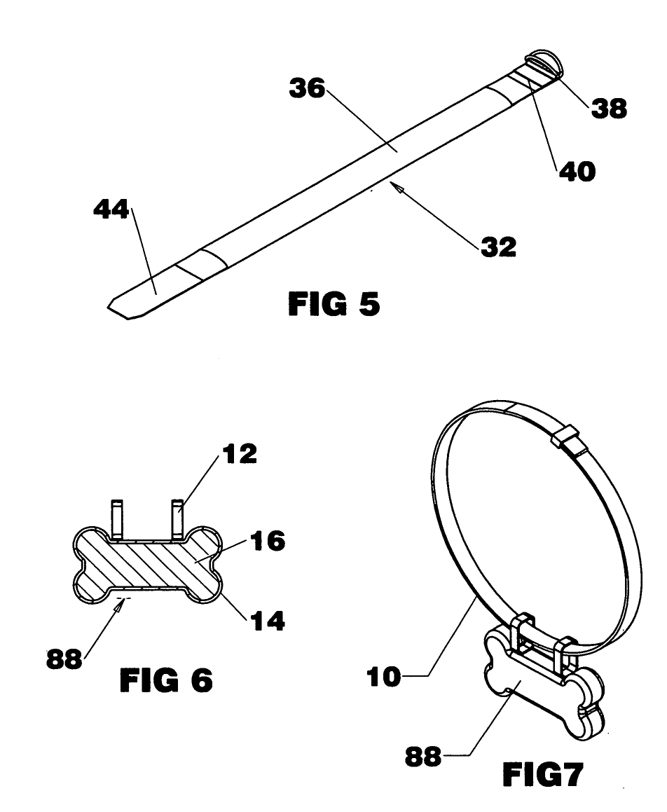

In another alternate embodiment, the odor-removing article is attached to a conventional pet collar as illustrated in FIG. 6 and FIG. 7.

The overall deodorizing pet pendant 88 consists of a pet pendant outer shell 14, which is made from a permeable material to allow air infiltration to the granular activated carbon 16, contained within said pendent shell 14.

Attached to the shell 14 are two pendant loops 12 which are affixed to the pendant shell 14 by sewing or other suitable method. The pendant shell 14 is filled with granular activated carbon 16, which is the component responsible for entrapping odor molecules. The deodorizing pendant 88 is shown in its intended use as attached to a convention collar 10.

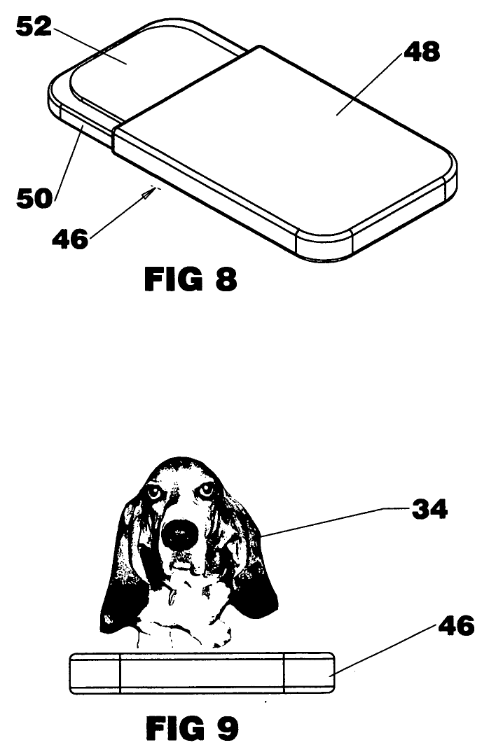

Another alternate embodiment exists whereby the pet will lie on the odor-removing article as illustrated in FIG. 8 and FIG. 9.

The pet pad 46 contains a deodorizing activated carbon component, 52 which is the mechanism to odor reducing mechanism. The pet bed cover 48 covers both the pet bed foam pad 50 as well as the pet bed-deodorizing pad 52.

The deodorizing pad 52 may be removed and replaced periodically as the effectiveness of its activated carbon is exhausted having absorbed pet and other surrounding odors.

It is clear to those familiar in the arts that alternately:

Stitching technology may be replaced by other means to join materials together.

Attachment means of collar may use laces, ties, or the like to eliminate the buckle.

Internal pouch assembly contained within the deodorized collar may be eliminated in lieu of filling a segmented collar body itself with activated carbon.

The activated carbon may be replaced with activated carbon that is impregnated into cloth, foam, thread, or other configuration, which contains an adequate activated carbon density to enable the product to remove odors.

Activated carbon may be replaced with activated charcoal, zeolites, or other types of molecular sieve that serves the same basic purpose as described within this invention. Material selection used to house the activated carbon implies any material that can retain the activated carbon in the spirit of the embodiments shown herein.

While the invention has been described in connection with detailed embodiments, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An article of manufacture worn around a pet's neck for removing pet odors comprising:
A deodorizer element;
A permeable cover encasing the deodorizer element; and
An attachment means to secure the article.

2. An article of manufacture as claimed in claim 1 whereas said deodorizer is activated carbon or other molecular sieve.

3. An article of manufacture for removing pet odors as claimed in claim 1 wherein said article attaches to an existing pet collar.

4. An article of manufacture worn around a pet's neck for removing pet odors as claimed in claim 1 wherein said article is disposable.

5. An article of manufacture on which a pet will lie for removing pet odors comprising:
A deodorizer element;
A permeable cover encasing the deodorizer element;

6. An article of manufacture as claimed in claim 5 whereas said deodorizer is activated carbon or other molecular sieve.
